(19) United States
(12) Patent Application Publication
(10) Pub. No.: US 2023/0147500 A1
(43) Pub. Date: May 11, 2023

(54) INSERT PRECISION-INTEGRATED INTO A BLANK BODY BY ADDITIVE MANUFACTURING

(71) Applicant: VALLOUREC OIL AND GAS FRANCE, Aulnoye-Aymeries (FR)

(72) Inventor: Eric VERGER, Meudon (FR)

(73) Assignee: VALLOUREC OIL AND GAS FRANCE, Aulnoye-Aymeries (FR)

(21) Appl. No.: 17/996,873

(22) PCT Filed: Apr. 16, 2021
(86) PCT No.: PCT/EP2021/059858

§ 371 Date: Oct. 21, 2022

(30) Foreign Application Priority Data
Apr. 22, 2020 (FR) FR2004017

(51) Int. Cl. F16L 15/00; F16L 25/14; F16L 41/02; B23K 9/04; B33Y 10/00; B33Y 40/20; B33Y 80/00

(52) U.S. Cl. CPC F16L 15/001; F16L 25/14; F16L 41/023; B23K 9/044; B33Y 10/00; B33Y 40/20; B33Y 80/00; E21B 17/042

(57) ABSTRACT

A steel pipe is for drilling, exploiting hydrocarbon wells, transporting petrol and gas, carbon capture or geothermal energy. The steel pipe includes at least one male or female insert and a metal body. The insert includes at least a first thread axis, at least one toric or frusto-conical sealing surface, a threaded portion and a non-threaded portion connected to the metal body. The metal body is made entirely by additive manufacturing and the insert includes an anchoring profile arranged so as to adhere the additive material of the metal body.

The invention relates to steel components or pipes in the field of oil and gas, energy or storage, for a use such as well operation or the transport of hydrocarbons, geothermal energy or carbon capture.

A “component” is understood here to be any element, accessory or pipe which is used for drilling or operating a well and comprises at least one connection or connector or a threaded end, and is intended to be joined to another component by way of a thread to form a threaded joint with this other component. The component may be for example a tube or a tubular element of relatively great length (in particular around 10 meters in length), for example a tube, or a tubular sleeve with a length of a few tens of centimeters, or an accessory of these tubular elements (a hanging device or “hanger”, a section changing part or “cross-over”, a safety valve, a connector for a drill string or “tool joint”, “sub”, or the like).

The components or pipes are provided with threaded ends. These threaded ends are complementary, making it possible to join a male tubular element (“pin”) and a female tubular element (“box”) together. There is therefore a male threaded end and a female threaded end. Threaded ends referred to as premium or semi-premium generally have at least one stop surface. A first stop may be formed by two surfaces of two threaded ends, which are oriented substantially radially, configured so as to be in contact with one another once the threaded ends have been screwed together or under compressive loadings. The stops generally exhibit negative angles with respect to the main axis of the connections. Intermediate stops on joints having at least two thread stages are also known.

It may be necessary for a pipe to have a metal body with a non-tubular or non-rectilinear shape. Specifically, a pipe may comprise a portion that is not straight, for example a curved shape or S shape, or changes in inside or outside diameter. However, the current means for achieving this are extremely limited and non-functional.

Generally, for technical and machining reasons, the different parts of one and the same component, be this the body of the tubular element or the threaded ends, are designed with one and the same type of material (which is or is not an alloy).

The tubes are generally rectilinear, or rectilinear axis, the two ends of a tube being aligned and therefore having end axes that are substantially collinear. However, there is a need in the hydrocarbon, geothermal energy or carbon capture industry for a tube or a pipe that has different geometric characteristics, in particular through the presence of an angular deviation in said tube between the axis of a first end and the axis of a second end. This type of geometry is very useful for providing branches, elbows, contours and other connections depending on the geology during drilling operations or for more easily arranging a flow transport. Furthermore, this makes it possible to save on the number of tubes used and the quantity of resources required. The current solutions are expensive to realize and/or have unsatisfactory mechanical characteristics.

To achieve this type of geometry with the means from the prior art, a first solution consists in starting from a solid metal part that is machined to achieve an angular deviation or non-coaxial terminal ends.

However, such a solution has a number of major drawbacks; in particular, during the production of these parts by turning. There is, for example, an out of balance during the production phase, that is to say a mass not perfectly distributed over a volume of revolution resulting in an imbalance, at the deflected or deformed part of the tube. But there are also vibrations and wear at the time of machining, which greatly weaken the tube and make it less reliable. There are also geometry defects, non-respected tolerances and pressure drops during hydraulic flows.

A second solution consists in designing and producing a (non-machined) tube directly with the desired geometry, for example a tube that exhibits in this body an elbow or an angular offset between the axis of a first end and that of a second end. However, the drawbacks will arise at the time of the machining of the thread, which will be very complicated to produce. This is because such a geometry will make it necessary to create a method and apparatuses that are specifically designed. This therefore involves significant costs and a very low production rate associated with complex machining that is inconceivable industrially.

The document CN108278088 A describes a drill string made of composite material with a steel and aluminum gradient and the method for preparing it in order to develop a drill string that is lightweight, very strong, very resistant to temperature, wear resistant and corrosion resistant 10.

The document FR 2818 728 relates to tubular threaded joints made up of a male threaded element disposed at the end of a first tubular component and screwed to a female threaded element disposed at the end of a second tubular component.

The document WO2019/016254 discloses a method for manufacturing a connecting piece 15 intended to be connected to at least one tubular component.

The current means of the prior art are therefore limited and are unable to confer more geometric flexibility on the production of a tube without bringing about stresses and undesirable effects. They are even less capable of producing a steel tube for well operation or transport of hydrocarbons, geothermal energy or carbon capture with at least three terminal ends.

The aim of the present invention is to solve the problems of the cited prior art, by producing the metal body of a pipe entirely by additive manufacturing over at least one insert.

Therefore, the invention consists in a steel pipe (1) for drilling, operating hydrocarbon wells, transporting oil and gas, carbon capture or geothermal energy, comprising at least one male (2) or female (3) insert and a metal body (4), said insert (2, 3) comprising at least a first thread axis, at least one toric or frustoconical sealing surface (21, 22), a threaded part (5) and a non-threaded part (6) connected to the metal body (4), characterized in that the metal body (4) has been produced entirely by additive manufacturing.

According to one embodiment, the pipe (1) is characterized in that the minimum and radial thickness of an insert is determined according to the equation:

min thickness=Rext−(K*Epg+Ri) [Math 1]
where:
Min thickness minimum value of the thickness of an insert in mm
Rext value of the outside radius
Epg value of the thickness of a root of a thread tooth
Ri value of the inside radius
K value of the minimum thickness ratio, between 0.25 and 0.7.

According to one embodiment, the pipe (1) is characterized in that the thickness ratio K is equal to 0.510.

According to one embodiment, the pipe (1) is characterized in that a male (2) or female (3) insert comprises a determined minimum and radial thickness of between 4 mm and 20 mm.

According to one embodiment, the pipe (1) is characterized in that a male (2) or female (3) insert comprises a determined minimum and radial thickness of between 4 and 18 mm.

According to one embodiment, the pipe (1) is characterized in that a male (2) or female (3) insert comprises a determined minimum and radial thickness of between 4.5 and 16 mm.

According to one embodiment, the pipe (1) is characterized in that each of the male (2) or female (3) inserts has an outside diameter (OD) of between 100 mm and 480 mm.

According to one embodiment, the pipe (1) is characterized in that the metal body (4) has been produced by deposition by wire arc additive manufacturing.

According to one embodiment, the pipe (1) is characterized in that the metal body (4) adheres around the male (2) or female (3) insert to the non-threaded part thereof.

According to one embodiment, the pipe (1) is characterized in that the metal body (4) produced by additive manufacturing comprises a material of the metal type chosen from alloy steels, high-alloy steels, cupro-nickel alloys, titanium alloys, ceramics, vitroceramics, or copper, stellite, ferro 55.

According to one embodiment, the pipe (1) is characterized in that the metal body (4) produced by additive manufacturing comprises a material with a Young's modulus of between 110 GPa and 210 GPa, preferably between 160 GPa and 210 GPa.

According to one embodiment, the pipe (1) is characterized in that an insert (2, 3) comprises an anchoring profile (7) designed to adhere the additivated material of the metal body (4).

According to one embodiment, the pipe (1) is characterized in that the anchoring profile (7) comprises one or more shear surfaces (11) and/or at least one securing extension (12).

According to one embodiment, the pipe (1) is characterized in that it comprises at least two male (2) and/or female (3) inserts.

According to one embodiment, the pipe (1) is characterized in that each of said male (2) and/or female (3) inserts respectively has a first and a second thread axis A1 and A2, and in that said first and second axes A1 and A2 are non-collinear.

According to one embodiment, the pipe (1) is characterized in that the thread axis of a first male (2) or female (3) insert has an angle of inclination of between 0 and 75 degrees with respect to the axis of a second male (2) or female (3) insert.

According to one embodiment, the pipe (1) is characterized in that it comprises at least three male or female inserts (62, 63, 64), the inserts (62, 63, 64) respectively comprising at least a first thread axis, a second thread axis, a third thread axis, the inserts being connected by a body (4) produced entirely by additive manufacturing, said first, second and third axes of each of the male or female inserts (62, 63, 64) being non-collinear.

The invention also comprises a method for producing a pipe (1), comprising:
a step of holding one or more male (2) or female (3) inserts in a determined position.
a step of producing the metal body (4) by wire arc additive manufacturing comprising a deposition of material from a non-threaded portion of the insert (2, 3).
a step of heat treatment to modify the mechanical characteristics of the body and relieve the mechanical stresses brought about by the additive manufacturing.
a step of machining in the metal body (4).

Further features and advantages of the invention will become apparent from studying the following detailed description and the appended drawings.

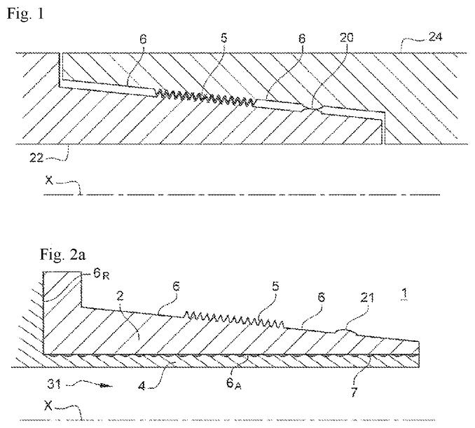

FIG. 1 schematically shows, in a view in longitudinal section, a tubular threaded joint according to the prior art.

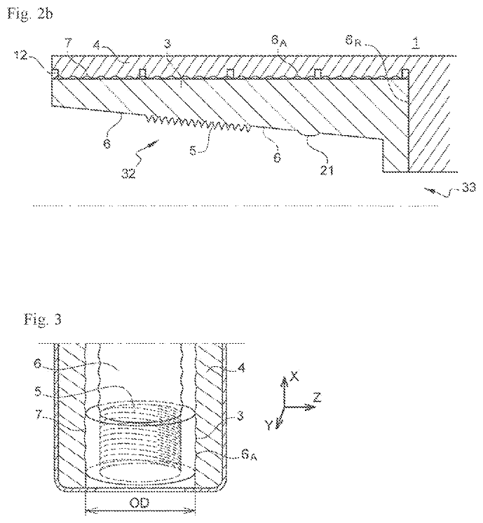

FIG. 2a schematically shows, in a view in longitudinal section, a male steel pipe portion according to a first embodiment, in which the metal body has been produced entirely by additive manufacturing around an insert.

FIG. 2b schematically shows, in a view in longitudinal section, a female steel pipe portion according to a second embodiment, in which the metal body has been produced entirely by additive manufacturing around an insert.

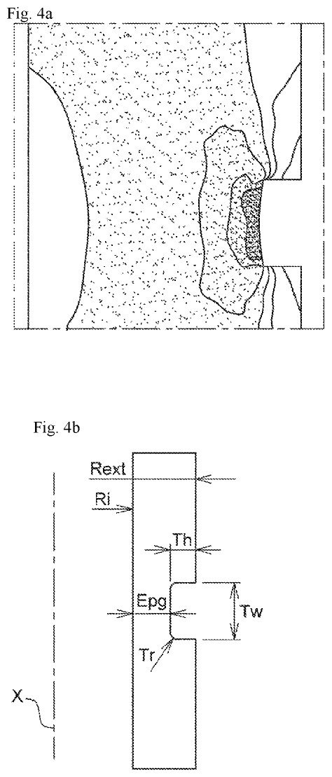

FIG. 3 schematically shows, in a hybrid perspective view, a steel pipe comprising a female insert and a metal body portion produced entirely by additive manufacturing.

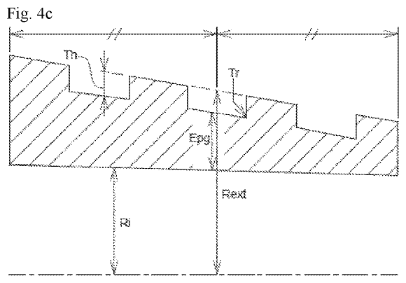

FIG. 4a shows a diagram of stress concentration in a thread tooth according to the invention and on a tone scale.

FIG. 4b shows a schematic diagram of a portion of an insert according to the invention.

FIG. 4c shows a schematic diagram of a portion of a connection repeating the parameters of FIG. 4b.

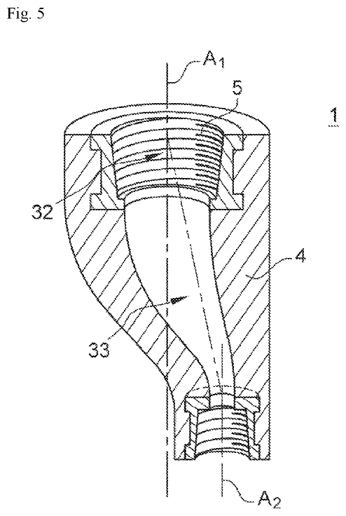

FIG. 5 shows a hybrid perspective view of a pipe according to a variant of the invention comprising two non-coaxial inserts.

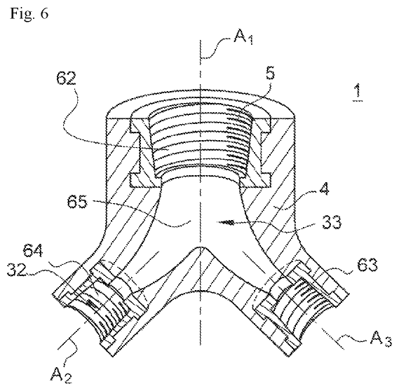

FIG. 6 shows a hybrid perspective view of a pipe according to a variant of the invention comprising three non-coaxial inserts.

The appended drawings may not only serve to make the invention easier to understand, but also contribute toward defining it, if need be. They are not limiting with regard to the scope of the invention.

FIG. 1 schematically shows, in a view in longitudinal section, a tubular threaded joint of the prior art. The tubular threaded joint comprises a male element (22) and a female element (24) in an assembled or connected state. Each element comprises a threaded part (5) and a non-threaded part (6). The tubular threaded joint comprises a seal (20) formed by interfering contact of two sealing surfaces of the toric or frustoconical type on either side of each of said male and female elements in the assembled state. Each of the portions of an element are made from one and the same type of material, that is to say in particular the threaded part, the non-threaded part and the sealing surface. There are therefore not two different types of material for two different parts of the tube. Each of the male (22) or female (24) elements is rectilinear and has a common axis of revolution at its male end, its main tubular body and its other end (not shown).

In order to be able to obtain a pipe with a geometry more complex than a simple straight tubular shape, that is to say to obtain a component having, for example, terminal ends that are non-coaxial and/or non-coplanar, two solutions have been proposed to date, both of which require a type of direct intervention on a part or on the tube.

FIG. 2a shows a steel pipe (1) comprising a male insert (2) and a metal body (4), said insert (2) comprising at least a first thread axis (indicated by the axis X), at least one sealing surface (21) that may be toric or frustoconical, a threaded part (5) and a non-threaded part (6) connected to the metal body (4). The metal body (4) has been produced entirely by additive manufacturing. The insert (2) may advantageously comprise an anchoring profile (7) designed to adhere the additivated material of the metal body (4).

According to one aspect of the invention, a non-threaded part (6) comprises a radial surface (6R), which may be perpendicular to the thread axis. This surface may extend radially. A non-threaded part (6) may also comprise an axial surface (6A) on the opposite side from the threaded part (5). This surface (6A) may be parallel to the thread axis. This axial surface (6A) may extend axially.

According to one embodiment, the non-threaded part (6) denotes the surface on the opposite side from the threaded part, parallel to the thread axis. It also denotes the radial surface of the insert (perpendicular to the thread axis).

According to one embodiment, the metal body (4) has been produced by deposition by wire arc additive manufacturing. Advantageously, the wire arc additive manufacturing confers good structural integrity and low distortion on the additivated material. It does not require complex tooling and optimizes material losses, thereby lowering the production costs.

Advantageously, the metal body (4) produced entirely by additive manufacturing allows ease of geometric configuration. In this way, it is possible to obtain a pipe configured according to the geometric or geological difficulty encountered during well operation or the transport of hydrocarbons, geothermal energy or carbon capture.

Advantageously, a pipe according to the invention has much smoother hydraulic flow that can be obtained more easily compared with the solutions of the prior art, in particular through the absence of an out of balance on machining.

Advantageously, the material of the metal body (4) may be different than that of the insert. Therefore, where possible, a material can be chosen that is less expensive than that of the insert, thereby reducing costs. It is also possible to choose materials having different properties with respect to the insert depending on the desired use.

Advantageously, the metal body (4) produced by additive manufacturing comprises a material of the metal type chosen from alloy steels, high-alloy steels, cupro-nickel alloys, titanium alloys, ceramics, vitroceramics, or copper, stellite, ferro 55.

Advantageously, the production and machining time is significantly reduced and compatible with industrial requirements.

Advantageously, the metal body (4) may be produced by additive manufacturing using a material with a Young's modulus of between 110 GPa and 210 GPa. Preferably, the body may be produced with a material having a Young's modulus of 160 to 210 GPa in order to approach that of the male insert. This is because, under the same stress, a material having a high modulus of elasticity will undergo less deformation than a material having a low modulus of elasticity.

For example, with the elastic limits of the materials being able to be between 300 MPa and 950 MPa, an insert may comprise a material made of steel, of alloy steel, Inconel, a nickel base or a steel of the 13cr or super 13cr standards.

The insert should be a controlled part, the dimensions of which need to comply with tolerances. The insert (2) may be machined by conventional methods with high precision. The insert may be obtained separately from the body (4). Advantageously, obtaining the insert (2) overcomes constraints imposed by the geometry of a pipe of complex shape. The term tolerance means the difference between two limit sizes considered to be in accordance with the nominal dimensions fixed in advance on a plan.

Moreover, the body (4) is obtained by being built by additive manufacturing over the insert (2). Thus, with an insert that is already controlled, it is much easier to confer a complex geometric shape on the pipe (1), avoiding all the machining problems associated with a thread. A complex geometric shape may be a shape that is both rectilinear and/or non-rectilinear along the entire length of the pipe.

According to one embodiment, the anchoring profile (7) may comprise a shear surface (11) and/or a securing extension (12). The anchoring profile (7) may also comprise annular undulations, or annular ribs.

Advantageously, the anchoring profile (7) makes it possible to increase and ensure the adhesion of the material of the additivated body to the insert.

Advantageously, an anchoring profile (7) comprising one or more shear surfaces (11) allows better interpenetration between the insert and the material realized by additive manufacturing of the body.

Advantageously, an anchoring profile (7) comprising one or more securing extensions (12) allows better attachment of the material added by additive manufacturing.

The applicant has determined additional conditions linking the insert and the part added by additive manufacturing in order to ensure the integrity of the pipe. A transition zone between a material of the insert and that of the metal body is determined according to the equation:

σzz≥85% Ys [Math 2]
where:
σzz value of the stress generated
Ys value of the elastic limit of an insert

The transition zone between a metal insert (2) and the metal body (4) is conditioned by a minimum safety threshold of 85% Ys, Ys being the elastic limit of the material of the insert and σzz corresponding to the stress generated. The transition zone is contained in the insert. It is thus possible to make a transition between the metal material of the insert and an additivated material, on reaching at least 85% Ys, without there being a risk of adding additional stresses. The transition zone is contained in the insert and corresponds to the minimum and radial wall thickness of the insert measured radially.

Specifically, from 85% of Ys, materials can be found for the additivated material with elastic limits of up to 15% less compared with the material of the insert. Surprisingly, with a choice of material for the additivated material having elastic limits up to 15% less, there are fewer shear stresses, better material integrity and better adhesion.

For example, an insert having a strength of 125 ksi (≈862 MPa) could allow an addition of additivated material, that is to say the material produced by additive manufacturing, of 106 ksi (≈862 MPa). Thus, a material can be chosen that is much less expensive while remaining within acceptable limits.

Thus, the minimum and radial thickness of an insert is determined by the equation:

min thickness=Rext−(K*Epg+Ri) [Math 3]

where:
Min thickness minimum value of the thickness of an insert
Rext value of the outside radius
Epg value of the thickness of a root of a thread tooth
Ri value of the inside radius
K value of the minimum thickness ratio

K corresponds to a minimum thickness ratio that is necessary to achieve the minimum transition zone of 85% of the elastic limit Ys. The transition zone is contained in the insert and corresponds to the minimum wall thickness of the insert measured radially. The inventors have determined, following a number of simulations of the FEA type, that K could be between 0.25 and 0.70 and preferably 0.510.

During the simulation, several parameters were taken into account, which are shown in particular in FIG. 4b, namely the outside radius Rext, the inside radius Ri, the root thickness of the thread Epg, the depth of the thread Th, and lastly the main driver of the stress concentration factor Tr.

The outside radius Rext is understood to be the mean radius of the outer surface of the thread surface (T) of the connection.

The inside radius Ri is understood to be the inside radius of the connection.

The root thickness of the thread Epg is understood to be the thickness between the thread root and the inside radius.

The depth of the thread Th is understood to be the height of a thread.

The main driver of the stress concentration factor Tr is understood to be the radius that connects the flank of a thread to the thread root.

The coefficient K is understood to be a minimum thickness ratio of Epg necessary for achieving the transition zone with 85% of the elastic limit Ys. K is a dimensionless real number contained between two well-defined values 0.25 and 0.70. The applicant has determined that K depends on the parameters Ri, Rext, Tw, Tr, Th.

All of these parameters are applicable for FIGS. 4b and 4c. FIG. 4c illustrates the application of the parameters to a connection with a plurality of threads.

For example, the inventors carried out a test with a value chosen from the lowest values of the ranges and lines of products OCTG with:

Rext=89 mm,Ri=79 mm,Epg=8.5 mm,Th=1.5 mm,Tr=0.1 mm. [Math 4]

The following result was obtained:

$$( \frac{min thickness - Ri}{E p g} ) = 0.510 \qquad [ Math 5 ]$$

The minimum and radial thickness of an insert is therefore determined by the equation:

min thickness=Rext−(0.510*Epg+Ri) [Math 6]

K therefore corresponding to 0.510 for this simulation.

This equation therefore makes it possible to determine a minimum thickness of an insert while complying with the previous equation of σzz≥85% Ys.

The applicant has set out below a set of dimensions and values of thicknesses of inserts depending on the outside diameter (or “OD”, see FIG. 3), on the outside radius Rext, on the inside radius Ri, on the root thickness of the thread Epg, on the depth of the thread Th and on the thickness of the thread Tw. The value of the connecting radius Tr (in mm), which is a stress concentration factor, does not vary. A schematic depiction of all of these parameters is shown in FIG. 4b.

Some of these dimensions are recorded in the following table:

TABLE 1

| | | | | | | | Insert Thickness |
|---|---|---|---|---|---|---|---|
| OD | OD | Tw | Th | Rext | Ri | Epg | minimum |
| (inches) | (mm) | (mm) | (mm) | (mm) | (mm) | (mm) | (mm) |
| 4.5 | 114.3 | 8 | 1.2 | 57.2 | 49.15 | 6.8 | 4.532 |
| 4.5 | 114.3 | 10 | 1.2 | 57.2 | 47.15 | 8.8 | 5.512 |
| 7 | 177.8 | 9 | 1.4 | 88.9 | 79.9 | 7.6 | 5.124 |
| 7 | 177.8 | 12 | 1.4 | 88.9 | 76.9 | 10.6 | 6.594 |
| 9.625 | 244.5 | 9 | 1.58 | 122 | 113.2 | 7.425 | 5.21325 |
| 9.625 | 244.5 | 13 | 1.58 | 122 | 109.2 | 11.425 | 7.17325 |
| 13.625 | 346.1 | 9 | 1.9 | 173 | 164 | 7.1 | 5.379 |
| 13.625 | 346.1 | 25 | 1.9 | 173 | 148 | 23.1 | 13.219 |
| 16 | 406.4 | 14 | 1.9 | 203 | 189.2 | 12.1 | 7.829 |
| 16 | 406.4 | 30 | 1.9 | 203 | 173.2 | 28.1 | 15.669 |
| 18.625 | 473.1 | 15 | 1.9 | 237 | 221.5 | 13.1 | 8.319 |
| 18.625 | 473.1 | 37 | 1.9 | 237 | 199.5 | 35.1 | 19.099 |

Consequently, a pipe according to the invention may comprise an insert having an outside diameter (OD) of between 4 and 18.625 inches, or approximately between 100 mm and 480 mm.

A pipe according to the invention may therefore comprise a male insert (2) comprising a determined minimum and radial thickness of between 4 mm and 20 mm. The length of the male insert (2) is between 50 mm and 300 mm.

Advantageously, the invention makes it possible to manufacture a pipe by recovering old inserts and producing the metal body (4), produced entirely by additive manufacturing, around said inserts. This also makes it possible to use the invention on recovered tube portions intended to be restored, for example tube portions of which the ends are still functional.

FIG. 2b shows a steel pipe (1) comprising a female insert (3) and a metal body (4), said insert (3) comprising at least a first thread axis (indicated by the axis X), at least one sealing surface (21) that may be toric or frustoconical, a threaded part (5) and a non-threaded part (6) connected to the metal body (4). The metal body (4) has been produced entirely by additive manufacturing. The insert (3) may advantageously comprise an anchoring profile (7) designed to adhere the additivated material of the metal body (4).

According to one aspect of the invention, a non-threaded part (6) comprises a radial surface (6R), which may be perpendicular to the thread axis. This surface may extend radially. A non-threaded part (6) may likewise comprise an axial surface (6A) on the opposite side from the threaded part (5). This surface (6A) may be parallel to the thread axis. This axial surface (6A) may extend axially.

According to one embodiment, the non-threaded part (6) denotes the surface on the opposite side to the threaded part, parallel to the thread axis. It also denotes the radial surface of the insert (perpendicular to the thread axis).

According to one embodiment, the metal body (4) has been produced by deposition by wire arc additive manufacturing. Advantageously, wire arc additive manufacturing confers good structural integrity and low distortion on the additivated material. It does not require complex tooling and optimizes material losses, thereby lowering the production costs.

Advantageously, the material of the metal body (4) may be different than that of the insert. Therefore, where possible, a material can be chosen that is less expensive than that of the insert, thereby reducing costs. It is also possible to choose materials having different properties with respect to the insert depending on the desired use.

Advantageously, the metal body (4) produced by additive manufacturing comprises a material of the metal type chosen from alloy steels, high-alloy steels, cupro-nickel alloys, titanium alloys, ceramics, vitroceramics, or copper, stellite, ferro 55.

Advantageously, the production and machining time is significantly reduced, allowing much more industrially conceivable production.

Advantageously, the metal body (4) is produced by additive manufacturing using a material with a Young's modulus of between 110 GPa and 210 GPa. Preferably, the body is produced with a material having a Young's modulus of 160 to 210 GPa in order to approach that of the male insert. This is because, under the same stress, a material having a high modulus of elasticity will undergo less deformation than a material having a low modulus of elasticity.

Advantageously, the insert is a controlled part in terms of its tolerances and its machining. The term tolerance means the difference between two limit sizes considered to be in accordance with the nominal dimensions fixed in advance on a plan. Thus, with an insert that is already controlled, it is much easier to confer a desired geometric shape on the pipe (1), avoiding all the machining problems associated with a thread.

According to one embodiment, the anchoring profile (7) may comprise a shear surface (11) and/or a securing extension (12).

Advantageously, the anchoring profile (7) makes it possible to increase and ensure the adhesion of the material of the additivated body to the insert.

Advantageously, an anchoring profile (7) comprising one or more shear surfaces (11) allows better interpenetration between the insert and the material realized by manufacturing of the body.

Advantageously, an anchoring profile (7) comprising one or more securing extensions (12) allows better attachment of the additivated material.

The female insert (3) also comprises a minimum and radial thickness linked to a transition zone between the insert and the metal body. The developments associated with the male insert (2) in FIG. 2a apply analogously to the female insert (3).

Consequently, a pipe according to the invention may comprise an insert having an outside diameter (OD) of between 4 and 18.625 inches, or between 100 mm and 480 mm.

A pipe according to the invention may therefore comprise a female insert (3) comprising a determined minimum and radial thickness of between 4 mm and 20 mm. The length of the female insert (3) is between 50 mm and 300 mm.

Advantageously, the invention makes it possible to remodel a pipe a very large number of times by recovering the inserts and remaking the metal body (4) produced entirely by additive manufacturing. This also makes it possible to use the invention on recovered tube portions intended to be restored, for example tube portions of which the ends are still functional.

FIG. 3 schematically shows, in a perspective view, a steel pipe comprising a female insert (3) and a metal body portion (4) produced entirely by additive manufacturing.

The female insert (3) comprises at least a first thread axis (indicated by the axis X), at least one sealing surface (21) that may be toric or frustoconical (not shown), a threaded part (5) and a non-threaded part (6) connected to the metal body (4). The metal body (4) has been produced entirely by additive manufacturing. The insert (3) may advantageously comprise an anchoring profile (7) designed to adhere the additivated material of the metal body (4).

The female insert (3) comprises in particular an outside diameter OD of between 4 and 18.625 inches, or between 100 mm and 480 mm.

FIG. 3 is merely for illustrative purposes and is not systematically true to scale.

FIG. 4a shows a diagram of stress concentration at a thread root according to the invention and on a tone scale. FIG. 4b shows a schematic diagram of a thread tooth according to the invention a diagram of stress concentration.

It is apparent from FIG. 4a that the stress concentrations are much greater at the root of a thread tooth (the darkest part of the diagram). With increasing distance from the thread root, the stresses are lower in the insert. Conversely, the value of the stress generated increases (lighter zones to darker zones) from the inside radius Ri to the distance Inside radius+Thickness of the root (Ri+Epg).

An additivated material needs, inter alia, to confer properties of resistance to elastic deformation that are similar to those of the material of the insert. This is because a material having a high modulus of elasticity will undergo less deformation than a material having a low modulus of elasticity.

Advantageously, determining the minimum and radial thickness of the insert according to the equation min thickness=Rext−(K*Epg+Ri) makes it possible to know the threshold from which the transition between the material of the insert and that of the additivated material occurs safely without generating additional stresses. That is to say from 85% of the elastic limit Ys of the material of the insert.

The additional stresses may correspond to shear stresses, to stresses brought about by the additivated material by direct action on the insert, or to equivalent Von Mises stresses, that is to say a parameter that combines all of the stresses applied and that can be compared directly with the elastic limit.

where:
Min thickness minimum value of the thickness of an insert
Rext value of the outside radius
Epg value of the thickness of a root of a thread tooth
Ri value of the inside radius
K value of the minimum thickness ratio.

FIG. 4b is merely for illustrative purposes and is not systematically true to scale.

FIG. 5 shows, in a hybrid view in cross section and in perspective, a pipe according to a variant of the invention comprising two non-coaxial inserts.

A pipe according to this variant therefore comprises two inserts which may be male (2) and/or female (3).

Generally, a pipe insert (2, 3) comprises an interior space (31, 32).

A metal body (4) produced entirely by additive manufacturing connects the inserts (2, 3) and comprises a body interior space (33) communicating with the interior spaces (31, 32) of the inserts (2, 3).

In the case of FIG. 5, two female inserts (3) are shown.

Each of the male (2) or female (3) inserts may comprise a minimum and radial thickness associated with a transition zone between the insert and the metal body. The developments associated with the male insert (2) in FIG. 2a and the developments associated with the female insert (3) in FIG. 2b apply analogously to each of said male (2) or female (3) inserts in FIG. 5.

A first insert (2, 3) comprises a first thread axis A1. A second insert (2, 3) likewise comprises a second thread axis A2.

The first and second axes A1 and A2 may be collinear.

The first and second axes A1 and A2 may be parallel to one another and non-secant, having no point in common.

The first and second axes A1 and A2 may be non-parallel to one another and secant, having a point in common.

The first and second axes A1 and A2 may be non-parallel to one another and non-secant, having no point in common.

The three last configurations consequently allow the inserts (2, 3) to be offset in space. The pipe (1) thus comprises an interior space joining together the interior spaces of the inserts and of the body and this pipe interior space is non-rectilinear.

The thread axis of a first male (2) or female (3) insert is inclined with respect to the axis of a second male (2) or female (3) inserts of one and the same pipe (1). This angle of inclination is between 0 and 75 degrees.

Also, a pipe (1) may allow male (2) or female (3) inserts with different dimensions. For example, a different minimum and radial thickness of between 4 mm and 20 mm for each of the inserts, or a different outside diameter OD of between 4 and 18.625 inches, or approximately between 100 mm and 480 mm, for each of the inserts. The pipe shown in FIG. 5 comprises a first insert with an outside diameter larger than the outside diameter of the second insert. The first insert has a thickness greater than the thickness of the second insert.

Advantageously, the metal body (4) produced entirely by additive manufacturing allows ease of geometric configuration. In this way, it is possible to obtain a pipe configured according to the geometric or geological difficulty encountered during well operation or the transport of hydrocarbons, geothermal energy or carbon capture.

Advantageously, a pipe according to the invention has an interior space designed for a hydraulic flow which has reduced turbulence by virtue of smooth variations in section and can be obtained more easily compared with the solutions of the prior art, in particular through the absence of an out of balance on machining.

FIG. 6 shows a hybrid view in cross section and in perspective of a pipe according to another variant of the invention comprising three non-coaxial inserts.

According to one aspect of this variant, a pipe comprises three inserts which may be male and/or female (62, 63, 64). A metal body (65) produced entirely by additive manufacturing is connected to each of these inserts (62, 63, 64). In this way, the male and/or female inserts therefore belong to the same pipe (1).

The inserts (62, 63, 64) comprise insert interior spaces. The metal body (65) comprises a body interior space communicating with the insert interior spaces such that all of the interior spaces are in communication.

In the case of FIG. 6, three female inserts are shown.

Each of the male or female inserts may comprise a minimum thickness associated with a transition zone between the insert and the metal body. Thus, the developments associated with the male insert (2) in FIG. 2a and the developments associated with the female insert (3) in FIG. 2b apply analogously to each of said non-coaxial male (2) or female (3) inserts in FIG. 6. For example, the dimensions of the inserts (3) in FIG. 6 are not systematically the same.

A first insert (2, 3) comprises a first thread axis A1. A second insert (2, 3) likewise comprises a second thread axis A2. A third insert comprises a third thread axis A3.

The first, second and third axes A1, A2, A3 may be non-parallel to one another and secant, having at least one point in common.

The first, second and third axes A1, A2, A3 may be non-parallel to one another and non-secant, having no point in common.

The first, second and third axes A1, A2 and A3 may not all be parallel to one another, but two of the three axes may be collinear. The third axis is therefore not collinear with the two other axes.

Advantageously, the metal body (4) produced entirely by additive manufacturing allows ease of geometric configuration. In this way, it is possible to obtain a pipe configured according to the geometric or geological difficulty encountered during well operation or the transport of hydrocarbons, geothermal energy or carbon capture.

Advantageously, a pipe (1) according to this variant of the invention makes it possible to create a customized a distribution network with, for example, several outlet points and several inlet points.

Advantageously, a pipe (1) according to this variant of the invention makes it possible to reduce the number of pipes or tubes necessary during an operation in the field of oil, gas, carbon capture or geothermal energy.

Advantageously, a pipe according to the invention has an interior space with smoothed dimensional variations, facilitating hydraulic flow that can be obtained more easily compared with the solutions of the prior art, in particular through the absence of an out of balance on machining.

The applicant has found that this type of pipe does not exist on the market of oil-related equipment, in particular because of being difficult to obtain with existing means.

Advantageously, the invention makes it possible to manufacture a pipe by recovering old inserts and producing the metal body (4), produced entirely by additive manufacturing, around said inserts. This also makes it possible to use the invention on recovered tube portions intended to be restored, for example tube portions of which the ends are still functional.

Analogously, the developments made in FIGS. 5 and 6 are applicable to pipes comprising more than three male (2) or female (3) inserts.

1-15. (canceled)

16. A steel pipe for drilling, operating hydrocarbon wells, transporting oil and gas, carbon capture or geothermal energy, the steel pipe comprising:
at least one male or female insert and a metal body, said insert comprising at least a first thread axis, at least one toric or frustoconical sealing surface, a threaded part and a non-threaded part connected to the metal body, wherein the metal body has been produced entirely by additive manufacturing, and in that a minimum and radial thickness of an insert is determined according to the following equation:
min thickness=Rext−(K*Epg+Ri)
wherein min thickness is a minimum value of the thickness of an insert in mm, Rext is a value of an outside radius, Epg is a value of a thickness of a root of a thread tooth, Ri is a value of an inside radius, and K is a value of a minimum thickness ratio and is between 0.25 and 0.7.

17. The pipe as claimed in claim 16, wherein the thickness ratio K is equal to 0.510.

18. The pipe as claimed in claim 16, wherein the minimum and radial thickness of the male or female insert is determined to be between 4 mm and 20 mm.

19. The pipe as claimed in claim 16, wherein each of the male or female inserts has an outside diameter of between 100 mm and 480 mm.

20. The pipe as claimed in claim 16, wherein the metal body has been produced by deposition by wire arc additive manufacturing.

21. The pipe as claimed in claim 16, wherein the metal body adheres around the male or female insert to the non-threaded part thereof.

22. The pipe as claimed in claim 16, wherein the metal body produced by additive manufacturing comprises a material of the metal type chosen from alloy steels, high-alloy steels, cupro-nickel alloys, titanium alloys, ceramics, vitroceramics, or copper, stellite, ferro 55.

23. The pipe as claimed in claim 16, wherein the metal body produced by additive manufacturing comprises a material with a Young's modulus of between 110 GPa and 210 GPa.

24. The pipe as claimed in claim 16, wherein the metal body produced by additive manufacturing comprises a material with a Young's modulus of between 160 GPa and 210 GPa.

25. The pipe as claimed in claim 16, wherein the male or female insert comprises an anchoring profile configured to adhere the additivated material of the metal body.

26. The pipe as claimed in claim 25, wherein the anchoring profile comprises one or more shear surfaces and/or at least one securing extension.

27. The pipe as claimed in claim 16, wherein the pipe includes at least two of the male or female inserts.

28. The pipe as claimed in claim 27, wherein each of said male or female inserts respectively has a first and a second thread axis and said first and second axes are non-collinear.

29. The pipe as claimed in claim 27, wherein the thread axis of a first male or female insert of the at least two of the male or female inserts has an angle of inclination of between 0 and 75 degrees with respect to the axis of a second male or female insert of the at least two of the male or female inserts on the pipe.

30. The pipe as claimed in claim 16, further comprising at least three of the male or female inserts, the inserts respectively comprising at least a first thread axis, a second thread axis, a third thread axis, the inserts being connected by a body produced entirely by additive manufacturing, said first, second and third axes of each of the male or female inserts being non-collinear.

31. A method for obtaining the pipe as claimed in claim 16, comprising:
holding one or more of the male or female inserts in a determined position;
producing the metal body by wire arc additive manufacturing comprising a deposition of material from the non-threaded portion of the insert;
heat treating to modify mechanical characteristics of the metal body and relieve mechanical stresses brought about by the additive manufacturing; and
machining in the metal body.
